(19) United States
(12) Patent Application Publication
(10) Pub. No.: US 2026/0092212 A1
(43) Pub. Date: Apr. 2, 2026

(54) SELECTIVE ETCH INHIBITOR COMPOUNDS AND RELATED METHODS

(71) Applicant: ENTEGRIS, INC., Billerica, MA (US)

(72) Inventors: Thomas Doundoulakis, Armonk, NY (US); Steven A. Lippy, Brookfield, CT (US)

(21) Appl. No.: 19/338,903

(22) Filed: Sep. 24, 2025

Related U.S. Application Data
(60) Provisional application No. 63/700,608, filed on Sep. 27, 2024.

(51) Int. Cl. C09K 13/06

(52) U.S. Cl. CPC C09K 13/06

(57) ABSTRACT

Selective etch inhibitor compounds and related methods are provided. A method comprises obtaining a composition comprising an inhibitor compound; and selectively etching silicon nitride from a structure comprising silicon nitride. A composition comprises a phosphoric acid compound, an alkyl ammonium silicate compound, and 1% to 25% by weight of an inhibitor compound based on a total weight of the composition.

### CROSS-REFERENCE TO RELATED APPLICATIONS

This application claims the benefit under 35 USC 119 of U.S. Provisional Patent Application No. 63/700,608, filed Sep. 27, 2024, the disclosure of which is hereby incorporated herein by reference in its entirety.

### FIELD

The present disclosure relates to compositions comprising selective etch inhibitor compounds and related methods.

### BACKGROUND

Manufacture of microelectronic devices involves material removal via etching. As aspect ratios of NAND structures increase, the use of current etch inhibitors may not overcome challenges associated with larger silicon loading windows, polysilicon compatibility, high K materials, and higher selectivity of the ratio of silicon nitride and silicon oxide of the NAND structures. The use of current etch inhibitors may have foaming issues during the etching process with the NAND structures.

### SUMMARY

Some embodiments relate to a composition comprising an inhibitor compound of the formula:

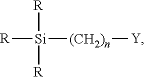

where:
R is independently an alkoxy or a hydroxyl;
n is at least 1; and
Y is a group of the formula:

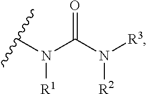

where:
R¹ is a hydrogen, an alkyl, a cycloalkyl, an aryl, an aralkyl, a silylalkyl, or an aminoalkyl; and
R² is a hydrogen, an alkyl, a cycloalkyl, an aryl, an aralkyl, a silylalkyl, or an aminoalkyl,
R³ is a hydrogen, an alkyl, a cycloalkyl, an aryl, an aralkyl, a silylalkyl, or an aminoalkyl, or
R² and R³ are bonded to each other to form a carbocycle or a heterocycle.

Some embodiments relate to a composition. In some embodiments, the composition comprises a phosphoric acid compound. In some embodiments, the composition comprises an alkyl ammonium silicate compound. In some embodiments, the composition comprises 1% to 25% by weight of an inhibitor compound based on a total weight of the composition,
wherein the inhibitor compound comprises a compound of the formula:

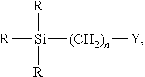

where:
R is independently an alkoxy or a hydroxyl;
n is at least 1; and
Y is a group of the formula:

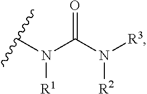

where:
R¹ is a hydrogen, an alkyl, a cycloalkyl, an aryl, an aralkyl, a silylalkyl, or an aminoalkyl; and
R² is a hydrogen, an alkyl, a cycloalkyl, an aryl, an aralkyl, a silylalkyl, or an aminoalkyl,
R³ is a hydrogen, an alkyl, a cycloalkyl, an aryl, an aralkyl, a silylalkyl, or an aminoalkyl, or
R² and R³ are bonded to each other to form a carbocycle or a heterocycle.

Some embodiments relate to a method. In some embodiments, the method comprises obtaining a composition comprising an inhibitor compound of the formula:

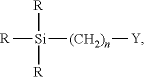

where:
R is independently an alkoxy or a hydroxyl;
n is at least 1; and
Y is a group of the formula:

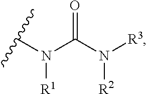

where:
R¹ is a hydrogen, an alkyl, a cycloalkyl, an aryl, an aralkyl, a silylalkyl, or an aminoalkyl; and
R² is a hydrogen, an alkyl, a cycloalkyl, an aryl, an aralkyl, a silylalkyl, or an aminoalkyl,
R³ is a hydrogen, an alkyl, a cycloalkyl, an aryl, an aralkyl, a silylalkyl, or an aminoalkyl, or
R² and R³ are bonded to each other to form a carbocycle or a heterocycle.

In some embodiments, the method comprises selectively etching silicon nitride from a structure comprising silicon nitride.

### BRIEF DESCRIPTION OF THE DRAWINGS

FIG. 1 is a flowchart of a method for selectively etching silicon nitride, according to some embodiments.

FIG. 2 is a reaction for the synthesis of urea alkoxy silane using isocyanate alkoxy silane, according to some embodiments.

FIG. 3 is a reaction for the synthesis of urea alkoxy silane using (Methylamino)trimethoxysilane, according to some embodiments.

FIG. 4 is a reaction for the synthesis of [[3-(3-ethyl-3-propylurea)propyl]tri(methoxy)silane using isocyanate alkoxy silane, according to some embodiments.

FIG. 5 is a reaction for the synthesis of [3-(3,3-dibutylurea)propyl]tri(methoxy)silane using isocyanate alkoxy silane, according to some embodiments.

FIG. 6 is a reaction for the synthesis of [(3,3-dimethylurea)methyl]tri(methoxy)silane using (Methylamino)trimethoxysilane, according to some embodiments.

### DETAILED DESCRIPTION

As used herein, the term “alkyl” refers to a hydrocarbyl having from 1 to 30 carbon atoms. The alkyl may be attached via a single bond. An alkyl having n carbon atoms may be designated as a “Cₙ alkyl.” For example, a “C₃ alkyl” may include n-propyl and isopropyl. An alkyl having a range of carbon atoms, such as 1 to 30 carbon atoms, may be designated as a C₁-C₃₀ alkyl. In some embodiments, the alkyl is linear. In some embodiments, the alkyl is branched. In some embodiments, the alkyl is substituted. In some embodiments, the alkyl is unsubstituted. In some embodiments, the alkyl comprises or is selected from the group consisting of at least one of a C₁-C₃₀ alkyl, C₁-C₂₉ alkyl, C₁-C₂₈ alkyl, C₁-C₂₇ alkyl, C₁-C₂₇ alkyl, C₁-C₂₆ alkyl, C₁-C₂₅ alkyl, C₁-C₂₄ alkyl, C₁-C₂₃ alkyl, C₁-C₂₂ alkyl, C₁-C₂₁ alkyl, C₁-C₂₀ alkyl, C₁-C₁₉ alkyl, C₁-C₁ alkyl, C₁-C₁₇ alkyl, C₁-C₁₆ alkyl, C₁-C₁₅ alkyl, C₁-C₁₄ alkyl, C₁-C₁₃ alkyl, C₁-C₁₂ alkyl, C₁-C₁₁ alkyl, C₁-C₁₀ alkyl, a C₁-C₉ alkyl, a C₁-C₈ alkyl, a C₁-C₇ alkyl, a C₁-C₆ alkyl, a C₁-C₅ alkyl, a C₁-C₄ alkyl, a C₁-C₃ alkyl, a C₁-C₂ alkyl, a C₂-C₃₀ alkyl, a C₃-C₃₀ alkyl, a C₄-C₃₀ alkyl, a C₅-C₃₀ alkyl, a C₆-C₃₀ alkyl, a C₇-C₃₀ alkyl, a C₈-C₃₀ alkyl, a C₉-C₃₀ alkyl, a C₁₀-C₃₀ alkyl, a C₁₁-C₃₀ alkyl, a C₁₂-C₃₀ alkyl, a C₁₃-C₃₀ alkyl, a C₁₄-C₃₀ alkyl, a C₁₅-C₃₀ alkyl, a C₁₆-C₃₀ alkyl, a C₁₇-C₃₀ alkyl, a C₁₈-C₃₀ alkyl, a C₁₉-C₃₀ alkyl, a C₂₀-C₃₀ alkyl, a C₂₁-C₃₀ alkyl, a C₂₂-C₃₀ alkyl, a C₂₃-C₃₀ alkyl, a C₂₄-C₃₀ alkyl, a C₂₅-C₃₀ alkyl, a C₂₆-C₃₀ alkyl, a C₂₇-C₃₀ alkyl, a C₂₈-C₃₀ alkyl, a C₂₉-C₃₀ alkyl, a C₂-C₁₀ alkyl, a C₃-C₁₀ alkyl, a C₄-C₁₀ alkyl, a C₅-C₁₀ alkyl, a C₆-C₁₀ alkyl, a C₇-C₁₀ alkyl, a C₈-C₁₀ alkyl, a C₂-C₉ alkyl, a C₂-C₈ alkyl, a C₂-C₇ alkyl, a C₂-C₆ alkyl, a C₂-C₅ alkyl, a C₃-C₅ alkyl, or any combination thereof. In some embodiments, the alkyl comprises or is selected from the group consisting of at least one of methyl, ethyl, n-propyl, 1-methylethyl (iso-propyl), n-butyl, iso-butyl, sec-butyl, n-pentyl, 1,1-dimethylethyl (t-butyl), n-pentyl, iso-pentyl, n-hexyl, isohexyl, 3-methylhexyl, 2-methylhexyl, heptyl, octyl, nonyl, decyl, dodecyl, octadecyl, or any combination thereof. In some embodiments, the term “alkyl” refers generally to alkyls, alkenyls, alkynyls, and/or cycloalkyls.

As used herein, the term “cycloalkyl” refers to a non-aromatic carbocyclic ring having from 3 to 8 carbon atoms in the ring. The term includes a monocyclic non-aromatic carbocyclic ring and a polycyclic non-aromatic carbocyclic ring. The term “monocyclic,” when used as a modifier, refers to a cycloalkyl having a single cyclic ring structure. The term “polycyclic,” when used as a modifier, refers to a cycloalkyl having more than one cyclic ring structure, which may be fused, bridged, spiro, or otherwise bonded ring structures. For example, two or more cycloalkyls may be fused, bridged, or fused and bridged to obtain the polycyclic non-aromatic carbocyclic ring. In some embodiments, the cycloalkyl may comprise, consist of, or consist essentially of, or may be selected from the group consisting of, at least one of cyclopropyl, cyclobutyl, cyclopentyl, cyclohexyl, cycloheptyl, cyclooctyl, or any combination thereof.

As used herein, the term “aryl” refers to a monocyclic or polycyclic aromatic hydrocarbon. The number of carbon atoms of the aryl may be in a range of 5 carbon atoms to 100 carbon atoms. In some embodiments, the aryl has 5 to 20 carbon atoms. For example, in some embodiments, the aryl has 6 to 8 carbon atoms, 6 to 10 carbon atoms, 6 to 12 carbon atoms, 6 to 15 carbon atoms, or 6 to 20 carbon atoms. The term “monocyclic,” when used as a modifier, refers to an aryl having a single aromatic ring structure. The term “polycyclic,” when used as a modifier, refers to an aryl having more than one aromatic ring structure, which may be fused, bridged, spiro, or otherwise bonded ring structures. In some embodiments, the aryl is —C₆H₅.

Non-limiting examples of aryls include, without limitation, at least one of benzene, toluene, xylene (e.g., o-xylene, m-xylene, p-xylene), t-butyltoluene (e.g., o-t-butyltoluene, m-t-butyltoluene, p-t-butyltoluene), ethylmethylbenzene (e.g., 1-ethyl-4-methylbenzene, 1-ethyl-3-methylbenzene), 1-isopropyl-4-methylbenzene, 1-t-butyl-4-methylbenzene, mesitylene, pseudocumene, durene, methylbenzene, dimethylbenzene, trimethylbenzene, ethylbenzene, diethylbenzene (e.g., 1,4-diethylbenzene), triethylbenzene, propylbenzene, butylbenzene, iso-butylbenzene, sec-butylbenzene, t-butylbenzene, hexylbenzene, styrene, naphthalene, anthracene, phenanthrene, biphenyl, terphenyl, methylnaphthalene, biphenylene, dimethylnaphthalene, methylanthracene, 4,4′-dimethylbiphenyl, bibenzyl, diphenylmethane, any isomer thereof, or any combination thereof, and the like.

As used herein, the term “amino” and/or “amine” refers to a functional group of formula —N(R^{a}R^{b}), wherein R^{a} and R^{b} are independently a hydrogen, an alkyl (as defined herein), an aminoalkyl (as defined herein), or a silyl (as defined herein), or R^{a} and R^{b} are bonded to each other to form a C₃-C₂₀ N-heterocycle. In some embodiments, the amino may comprise an alkylamino or a dialkylamino. In some embodiments, the amino may comprise at least one of methylamino, dimethylamino, ethylamino, diethylamino, isopropylamino, di-isopropylamino, butylamino, sec-butylamino, tert-butylamino, di-sec-butylamino, isobutylamino, di-isobutylamino, di-tert-pentylamino, ethylmethylamino, isopropyl-n-propylamino, or any combination thereof. Examples of the alkylamines may include, without limitation, one or more of the following: primary alkylamines, such as, for example and without limitation, methylamine, ethylamine, n-propylamine, isopropylamine, n-butylamine, sec-butylamine, isobutylamine, t-butylamine, pentylamine, 2-aminopentane, 3-aminopentane, 1-amino-2-methylbutane, 2-amino-2-methylbutane, 3-amino-2-methylbutane, 4-amino-2-methylbutane, hexylamine, 5-amino-2-methylpentane, heptylamine, octylamine, nonylamine, decylamine, undecylamine, dodecylamine, tridecylamine, tetradecylamine, pentadecylamine, hexadecylamine, heptadecylamine, and octadecylamine; secondary alkylamines, such as, for example and without limitation, dimethylamine, diethylamine, dipropylamine, diisopropylamine, dibutylamine, diisobutylamine, di-sec-butylamine, di-t-butylamine, dipentylamine, dihexylamine, diheptylamine, dioctylamine, dinonylamine, didecylamine, methylethylamine, methylpropylamine, methylisopropylamine, methylbutylamine, methylisobutylamine, methyl-sec-butylamine, methyl-t-butylamine, methylamylamine, methylisoamylamine, ethylpropylamine, ethylisopropylamine, ethylbutylamine, ethylisobutylamine, ethyl-sec-butylamine, ethylamine, ethylisoamylamine, propylbutylamine, and propylisobutylamine; and tertiary alkylamines, such as, for example and without limitation, trimethylamine, triethylamine, tripropylamine, tributylamine, tripentylamine, dimethylethylamine, methyldiethylamine, and methyldipropylamine. Examples of polyamines may include, without limitation, one or more of the following: ethylenediamine, propylenediamine, trimethylenediamine, tetramethylenediamine, 1,3-diaminobutane, 2,3-diaminobutane, pentamethylenediamine, 2,4-diaminopentane, hexamethylenediamine, heptamethylenediamine, octamethylenediamine, nonamethylenediamine, N-methylethylenediamine, N,N-dimethylethylenediamine, trimethylethylenediamine, N-ethylethylenediamine, N,N-diethylethylenediamine, triethylethylenediamine, 1,2,3-triaminopropane, hydrazine, tris(2-aminoethyl)amine, tetra(aminomethyl)methane, diethylenetriamine, triethylenetetramine, tetraethylpentamine, heptaethyleneoctamine, nonaethylenedecamine, and diazabicyloundecene. Unless otherwise provided herein, the terms “amine” and “amino” may be used interchangeably throughout this disclosure.

As used herein, the term “alkoxy” or “alkoxide” refers to a functional group of formula —OR^{c}, wherein R^{c} is an alkyl (as defined herein), a silylalkyl, a cycloalkyl, or an aryl. In some embodiments, the alkoxy may comprise, consist of, or consist essentially of, or may selected from the group consisting of, at least one of methoxy, ethoxy, methoxy, ethoxy, n-propoxy, 1-methylethoxy (isopropoxy), n-butoxy, iso-butoxy, sec-butoxy, tert-butoxy, or any combination thereof.

As used herein, the term “aralkyl” refers to an alkyl as defined herein, wherein at least one of the hydrogen atoms of the alkyl is replaced with an aryl as defined herein. In some embodiments, the term “aralkyl” refers to a functional group of formula -(alkyl)(aryl), wherein the alkyl is defined herein and the aryl is defined herein. In some embodiments, the aralkyl is —CH₂(C₆H₅).

As used herein, the term “aminoalkyl” refers to an alkyl as defined herein, wherein at least one of the hydrogen atoms of the alkyl is replaced with an amino as defined herein. In some embodiments, the term “aminoalkyl” refers to a functional group of formula -(alkyl)N(R^{b}RCR^{d}), wherein the alkyl is defined above and wherein R^{b}, R^{c}, and R^{d} are defined above. In some embodiments, the aminoalkyl is —CH₂N(CH₃)₂. In some embodiments, the aminoalkyl is —(CH₂)₃N(CH₃)₂. In some embodiments, the aminoalkyl is aminomethyl (—CH₂NH₂). In some embodiments, the aminoalkyl is N,N-dimethylaminoethyl (—CH₂CH₂N(CH₃)₂). In some embodiments, the aminoalkyl is 3-(N-cyclopropylamino)propyl (—CH₂CH₂CH₂NH—Pr).

As used herein, the term “silylalkyl” refers to an alkyl as defined herein, wherein at least one of the hydrogen atoms of the alkyl is replaced with a silyl as defined herein. In some embodiments, the term “silylalkyl” refers to a functional group of formula -(alkyl)Si(R^{e}R^{f}R^{g}), wherein the alkyl is defined above and wherein R^{e}, R^{f}, and R^{g} are defined above. In some embodiments, the silylalky is a functional group of formula —(CH₂)ₘSi(R^{e}R^{f}R^{g}), where m is 1 to 10 and where R^{e}, R^{f}, and R^{g} are defined above. In some embodiments, the silylalkyl is a functional group of formula —CH₂Si(CH₃)₃.

Some embodiments relate to selective etch inhibitor compounds and related methods.

Some embodiments relate to a composition. In some embodiments, the composition comprises an inhibitor compound of the formula:

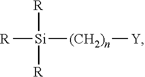

where:
R is independently an alkoxy or a hydroxyl;
n is at least 1; and
Y is a group of the formula:

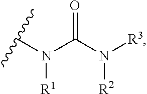

where:
R¹ is a hydrogen, an alkyl, a cycloalkyl, an aryl, an aralkyl, a silylalkyl, or an aminoalkyl; and
R² is a hydrogen, an alkyl, a cycloalkyl, an aryl, an aralkyl, a silylalkyl, or an aminoalkyl,
R³ is a hydrogen, an alkyl, a cycloalkyl, an aryl, an aralkyl, a silylalkyl, or an aminoalkyl, or
R² and R³ are bonded to each other to form a carbocycle or a heterocycle.

In some embodiments, when R² is a hydrogen and when R³ is a hydrogen, R¹ is not a hydrogen.

In some embodiments, R is —O(C₁-C₅alkyl) and n is 1 to 3.

In some embodiments, R¹ is a hydrogen; R² is a hydrogen; and R³ is a C₁-C₁₀ alkyl.

In some embodiments, R¹ is a hydrogen; R² is a hydrogen; and R³ is an aralkyl.

In some embodiments, R¹ is a hydrogen; R² is a hydrogen; and R³ is a silylalkyl.

In some embodiments, R¹ is a hydrogen; R² is an alkyl; and R³ is an alkyl.

In some embodiments, R¹ is a hydrogen; R² is an aralkyl; and R³ is a silylalkyl.

In some embodiments, R¹ is a hydrogen; R² is an alkyl; and R³ is an aminoalkyl.

In some embodiments, R¹ is a hydrogen; and R² and R³ are bonded to each other to form a heterocyclic ring or a substituted heterocyclic ring. In some embodiments, R² and R³ are not bonded to each other to form a heterocyclic ring or a substituted heterocyclic ring.

In some embodiments, Y is at least one of:

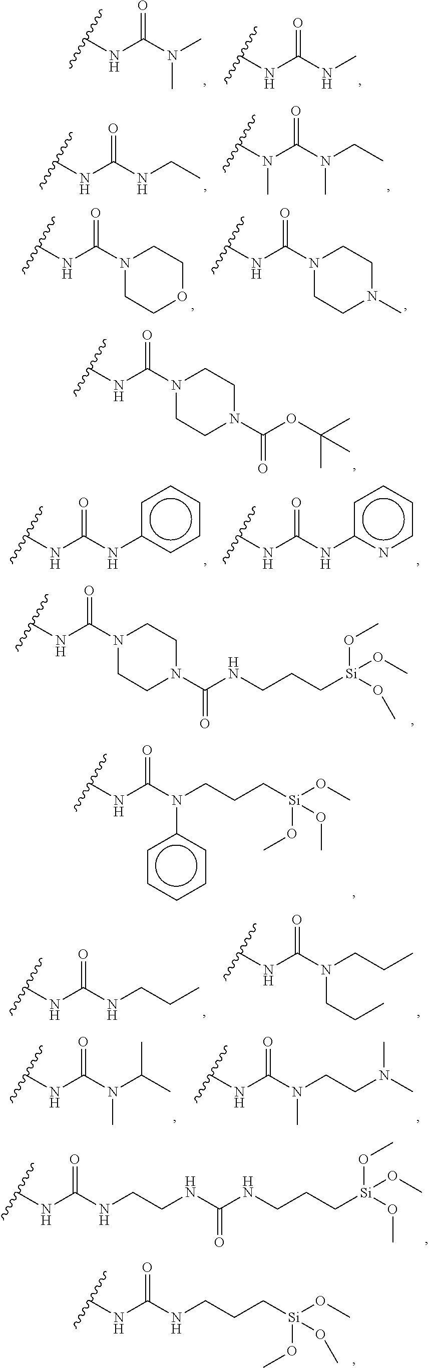

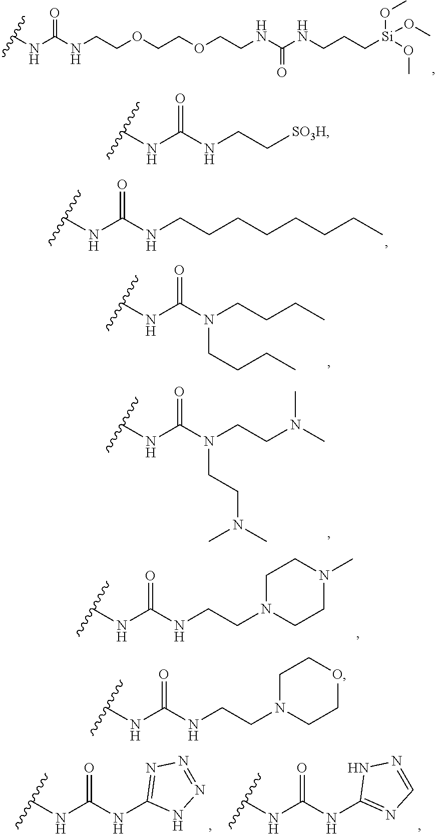

or
any combination thereof.

Some embodiments relate to a composition.

In some embodiments, the composition comprises a phosphoric acid compound.

In some embodiments, the composition comprises an alkyl ammonium silicate compound.

In some embodiments, the composition comprises 1% to 25% by weight of an inhibitor compound based on a total weight of the composition. In some embodiments, for example, the composition comprises 2% to 24%, 3% to 23%, 4% to 22%, 5% to 21%, 6% to 20%, 7% to 19%, 8% to 18%, 9% to 17%, 10% to 16%, 11% to 15%, or 12% to 14% by weight of an inhibitor compound based on a total weight of the composition. In some embodiments, the composition comprises 2% to 25%, 3% to 25%, 4% to 25%, 5% to 25%, 6% to 25%, 7% to 25%, 8% to 25%, 9% to 25%, 10% to 25%, 11% to 25%, 12% to 25%, 13% to 25%, 14% to 25%, 15% to 25%, 16% to 25%, 17% to 25%, 18% to 25%, 19% to 25%, 20% to 25%, 21% to 25%, 22% to 25%, 23% to 25%, or 24% to 25% by weight of an inhibitor compound based on a total weight of the composition. In some embodiments, for example, the composition comprises 1% to 24%, 1% to 23%, 1% to 22%, 1% to 21%, 1% to 20%, 1% to 19%, 1% to 18%, 1% to 17%, 1% to 16%, 1% to 15%, 1% to 14%, 1% to 13%, 1% to 12%, 1% to 11%, 1% to 10%, 1% to 9%, 1% to 8%, 1% to 7%, 1% to 6%, 1% to 5%, 1% to 4%, 1% to 3%, or 1% to 2% by weight of an inhibitor compound based on a total weight of the composition.

In some embodiments, the composition comprises the inhibitor compound comprises a compound of the formula:

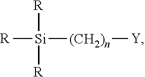

where:
R is independently an alkoxy or a hydroxyl;
n is at least 1; and
Y is a group of the formula:

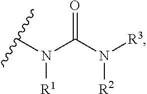

where:
R¹ is a hydrogen, an alkyl, a cycloalkyl, an aryl, an aralkyl, a silylalkyl, or an aminoalkyl; and
R² is a hydrogen, an alkyl, a cycloalkyl, an aryl, an aralkyl, a silylalkyl, or an aminoalkyl,
R³ is a hydrogen, an alkyl, a cycloalkyl, an aryl, an aralkyl, a silylalkyl, or an aminoalkyl, or
R² and R³ are bonded to each other to form a carbocycle or a heterocycle.

In some embodiments, the composition comprises 70% to 80% by weight of the phosphoric acid compound based on the total weight of the composition, or any range or subrange between 70% and 80%. In some embodiments, for example, the weight of the phosphoric acid compound based on the total weight of the composition may be 71% to 79%, 72% to 78%, 73% to 77%, or 74% to 76%. In some embodiments, the weight of the phosphoric acid compound based on the total weight of the composition may be 71% to 80%, 72% to 80%, 73% to 80%, 74% to 80%, 75% to 80%, 76% to 80%, 77% to 80%, 78% to 80%, or 79% to 80%. In some embodiments, for example, the weight of the phosphoric acid compound based on the total weight of the composition may be 70% to 79%, 70% to 78%, 70% to 77%, 70% to 76%, 70% to 75%, 70% to 74%, 70% to 73%, 70% to 72%, 70% to 71%.

In some embodiments, the composition comprises 1% to 20% by weight of the alkyl ammonium silicate compound based on the total weight of the composition, or any range or subrange between 1% and 20%. In some embodiments, for example, the weight of the alkyl ammonium silicate compound based on the total weight of the composition may be 2% to 19%, 3% to 18%, 4% to 17%, 5% to 16%, 6% to 15%, 7% to 14%, 8% to 13%, 9% to 12%, or 10% to 11%. In some embodiments, the weight of the alkyl ammonium silicate compound based on the total weight of the composition may be 2% to 20%, 3% to 20%, 4% to 20%, 5% to 20%, 6% to 20%, 7% to 20%, 8% to 20%, 9% to 20%, 10% to 20%, 11% to 20%, 12% to 20%, 13% to 20%, 14% to 20%, 15% to 20%, 16% to 20%, 17% to 20%, 18% to 20%, or 19% to 20%. In some embodiments, the weight of the alkyl ammonium silicate compound based on the total weight of the composition may be 1% to 19%, 1% to 18%, 1% to 17%, 1% to 16%, 1% to 15%, 1% to 14%, 1% to 13%, 1% to 12%, 1% to 11%, 1% to 10%, 1% to 9%, 1% to 8%, 1% to 7%, 1% to 6%, 1% to 5%, 1% to 4%, 1% to 3%, or 1% to 2%.

In some embodiments, the composition comprises 1% to 10% by weight of the inhibitor compound based on the total weight of the composition, or any range or subrange between 1% and 10%. In some embodiments, for example, the weight of the inhibitor compound based on the total weight of the composition may be 2% to 9%, 3% to 8%, 4% to 7%, or 5% to 6%. In some embodiments, the weight of the inhibitor compound based on the total weight of the composition may be 1% to 9%, 1% to 8%, 1% to 7%, 1% to 6%, 1% to 5%, 1% to 4%, 1% to 3%, or 1% to 2%. In some embodiments, the weight of the inhibitor compound based on the total weight of the composition may be 2% to 10%, 3% to 10%, 4% to 10%, 5% to 10%, 6% to 10%, 7% to 10%, 8% to 10%, or 9% to 10%.

In some embodiments, when R² is a hydrogen and when R³ is a hydrogen, R¹ is not a hydrogen.

In some embodiments, R is —O(C₁-C₅alkyl) and n is 1 to 3.

In some embodiments, R¹ is a hydrogen; R² is a hydrogen; and R³ is a C₁-C₁₀ alkyl, an aralkyl, or a silylalkyl.

In some embodiments, R¹ is a hydrogen; R² is an alkyl or an aralkyl; and R³ is an alkyl, a silylalkyl, or an aminoalkyl.

In some embodiments, R¹ is a hydrogen; and R² and R³ are bonded to each other to form a heterocyclic ring or a substituted heterocyclic ring.

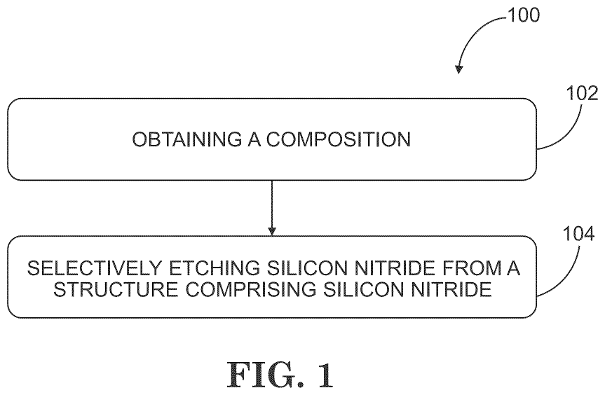

FIG. 1 is a flowchart of a method 100 for selectively etching silicon nitride, according to some embodiments. As shown in FIG. 1, the method 100 for selectively etching silicon nitride comprises one or more of the following steps: obtaining 102 a composition comprising an inhibitor compound; and selectively 104 etching silicon nitride from a structure comprising silicon nitride.

At step 102, the method 100 comprises obtaining a composition comprising an inhibitor compound of the formula:

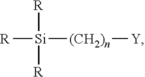

where:
R is independently an alkoxy or a hydroxyl;
n is at least 1; and
Y is a group of the formula:

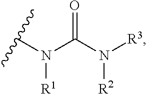

where:
R¹ is a hydrogen, an alkyl, a cycloalkyl, an aryl, an aralkyl, a silylalkyl, or an aminoalkyl; and
R² is a hydrogen, an alkyl, a cycloalkyl, an aryl, an aralkyl, a silylalkyl, or an aminoalkyl,
R³ is a hydrogen, an alkyl, a cycloalkyl, an aryl, an aralkyl, a silylalkyl, or an aminoalkyl, or
R² and R³ are bonded to each other to form a carbocycle or a heterocycle.

At step 104, the method 100 comprises selectively etching silicon nitride from a structure comprising silicon nitride. In some embodiments, the selectively etching comprises contacting the structure comprising silicon nitride with the composition. In some embodiments, the selectively etching comprises displacing the silicon nitride from the structure. In some embodiments, the selectively etching comprises disassociating the silicon nitride from the structure. In some embodiments, the selectively etching comprises extracting the silicon nitride from the structure. In some embodiments, the selectively etching comprises releasing the silicon nitride from the structure. In some embodiments, the selectively etching comprises removing the silicon nitride from the structure.

Any one or more of the embodiments disclosed herein shall be understood to be combinable without departing from the scope or spirit of the disclosure.

### Example 1

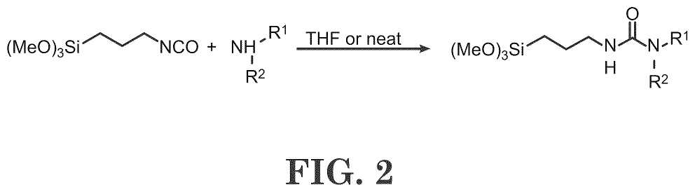

FIG. 2 is a general reaction for the synthesis of urea alkoxy silane using isocyanate alkoxy silane. Isocyanate alkoxy silane (compound I, FIG. 2) was stirred in a dry solvent, tetrahydrofuran (THF). Compound I was then cooled to 0° C. in an ice bath to form a cooled compound I solution. An amine compound was added for 10 minutes at 0° C. to react with the cooled compound I solution. R¹ and R² in the amine compound may be a functional group as described herein. The reaction was then stirred for 30 minutes at 0° C. to form a reaction product. The reaction product was then warmed to room temperature and stirred for 24 hours to 48 hours. THF was then removed under reduced pressure and the reaction product was dried under vacuum to remove any remaining residual solvent. Purification of the reaction product was carried out by distillation or normal phase column chromatography.

### Example 2

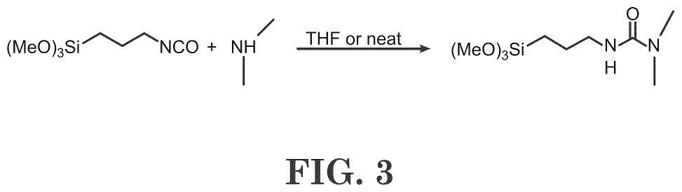

FIG. 3 is a reaction for the synthesis of [3-(3,3-dimethylurea)propyl]tri(methoxy)silane using isocyanate alkoxy silane. Isocyanate alkoxy silane (compound I, FIG. 3) is stirred in a dry solvent, tetrahydrofuran (THF). Compound I is then cooled to 0° C. in an ice bath to form a cooled compound I solution. Dimethylamine is added for 10 minutes at 0° C. to react with the cooled compound I solution. The reaction is then stirred for 30 minutes at 0° C. to form a reaction product, [3-(3,3-dimethylurea)propyl]tri(methoxy)silane. The reaction product is then warmed to room temperature and stirred for 24 hours to 48 hours. THF is then removed under reduced pressure and the reaction product is dried under vacuum to remove any remaining residual solvent. Purification of the reaction product is carried out by distillation or normal phase column chromatography.

### Example 3

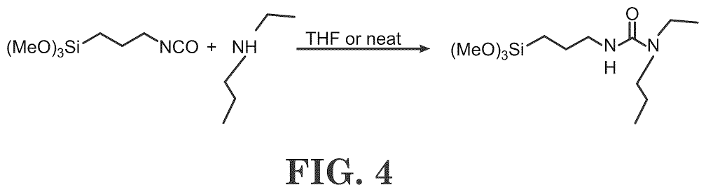

FIG. 4 is a reaction for the synthesis of [[3-(3-ethyl-3-propylurea)propyl]tri(methoxy)silane using isocyanate alkoxy silane. Isocyanate alkoxy silane (compound I, FIG. 4) is stirred in a dry solvent, THF. Compound I is then cooled to 0° C. in an ice bath to form a cooled compound I solution. N-ethylpropylamine is next added for 10 minutes at 0° C. to react with the cooled compound I solution. The reaction is then stirred for 30 minutes at 0° C. to form a reaction product, [3-(3-ethyl-3-propylurea)propyl]tri(methoxy)silane. The reaction product is warmed to room temperature and stirred for the next 24 hours to 48 hours. THF is then removed under reduced pressure and the reaction product is dried under vacuum to remove any remaining residual solvent. Purification of the reaction product is carried out by distillation or normal phase column chromatography.

### Example 4

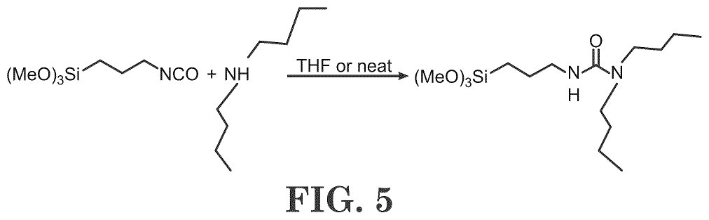

FIG. 5 is a reaction for the synthesis of [3-(3,3-dibutylurea)propyl]tri(methoxy)silane using isocyanate alkoxy silane. Isocyanate alkoxy silane (compound I, FIG. 5) is stirred in a dry solvent, tetrahydrofuran (THF). Compound I is then cooled to 0° C. in an ice bath to form a cooled compound I solution. Dibutylamine is next added for 10 minutes at 0° C. to react with the cooled compound I solution. The reaction is then stirred for 30 minutes at 0° C. to form a reaction product, [3-(3,3-dibutylurea)propyl]tri(methoxy)silane. The reaction product is then warmed to room temperature and stirred for the next 24 hours to 48 hours. THF is then removed under reduced pressure and the reaction product is dried under vacuum to remove any remaining residual solvent. Purification of the reaction product is carried out by distillation or normal phase column chromatography.

### Example 5

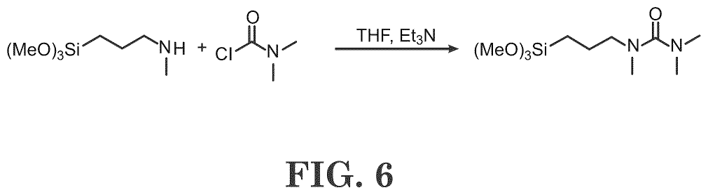

FIG. 6 is a reaction for the synthesis of [(3,3-dimethylurea)methyl]tri(methoxy)silane using (Methylamino)trimethoxysilane. (Methylamino)timethoxysilane (compound I, FIG. 6) was stirred in a dry solvent, THF. Compound I was then cooled to 0° C. in an ice bath to form a cooled compound I solution. Triethylamine was then added followed by the addition of dimethyl carbamoyl chloride. Solid triethylammonium chloride salts precipitated from the solution during the addition of dimethyl carbamoyl chloride. The reaction product, [(3,3-dimethylurea)methyl]tri(methoxy)silane was stirred for 30 minutes at 0° C. and warmed to room temperature. The reaction product was then stirred for 24 hours. The solid triethylammonium chloride salts were removed by filtration and the solvent, THF was removed using a rotary evaporator. The reaction product was then dried under vacuum to remove any remaining residual solvent. Purification of the reaction product was carried out by vacuum distillation at 120° C. and 50 mmHg.

### Example 6

Various compositions were prepared and the performance of each was evaluated. The etch rate using the compositions is summarized in Table 1. The additional element to each of the compositions is documented in Table 2. Control A and Control B were the control compositions, with Control A being a commercially available selective etch formulation available from Entegris, Inc. under the tradename Planar Etch 2141. Some components include replicates below.

TABLE 1

| | Etch Rates (A/min) at 160° C. | | | | | |
|---|---|---|---|---|---|---|
| Chemistry | SiN | SiN | Oxide | Oxide | dPolySi | dPolySi |
| Name | 0 ppm Si | 400 ppm Si | 0 ppm Si | 400 ppm Si | 0 ppm Si | 400 ppm Si |
| Control A | 167 | 153 | 0.4 | −0.3 | 4.7 | 3.9 |
| Control B | 169 | 131 | 0.3 | −0.1 | 4.8 | 3.6 |
| Component A | 169 | 134 | 0.5 | −0.2 | 2.2 | 2.3 |
| Component A | 167 | 139 | 0.3 | −0.2 | 1.8 | 1.3 |
| Component A | 165 | 136 | 0.6 | −0.1 | 2.3 | 1.8 |
| Component B | 157 | 138 | 0.4 | −0.2 | 5.5 | 5.2 |
| Component C | 159 | 132 | 0.5 | −0.1 | 4.8 | 4.4 |
| Component D | 156 | 123 | 0.4 | −0.2 | 4.9 | 4.7 |
| Component E | 161 | 125 | 0.1 | −0.2 | 2.5 | 2.4 |
| Component F | 157 | 125 | 0.4 | −0.2 | 7.3 | 5.9 |
| Component G | 160 | 123 | 0.1 | 0.0 | 4.1 | 4.0 |
| Component H | 157 | 128 | 0.4 | −0.2 | 6.2 | 4.4 |
| Component I | 169 | 138 | 0.3 | −0.1 | 4.8 | 4.9 |
| Component J | 163 | 135 | 0.5 | −0.1 | 5.7 | 4.7 |
| Component J | 155 | 134 | 0.7 | 0.0 | 4.8 | 5.1 |
| Component K | 153 | 123 | −0.1 | −0.1 | 3.9 | 4.0 |
| Component L | 166 | 130 | 0.2 | −0.2 | 4.4 | 4.6 |
| Component M | 167 | 138 | 0.4 | −0.1 | 6.2 | 6.5 |
| Component M | 156 | 128 | 0.4 | −0.1 | 7.7 | 5.6 |
| Component N | 164 | 131 | 0.3 | −0.1 | 5.8 | 5.4 |
| Component O | 158 | 128 | 0.4 | −0.2 | 4.6 | 5.1 |

TABLE 2
Tested Components

| Component | Structure | Name |
|---|---|---|
| A | 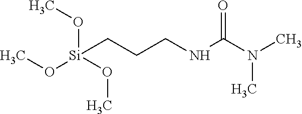 | N,N-Dimethyl-N′-[3- (trimethoxysilyl) propyl]urea |
| B | 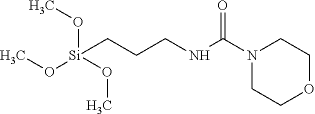 [SMILES: CO[Si](CCCNC(=O)N1CCOCC1)(OC)OC] | N-[3-(Trimethoxysilyl) propyl]-4- morpholinecarboxamide |
| C | 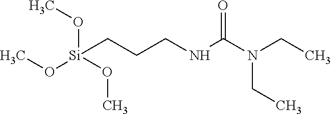 [SMILES: CCN(CC)C(=O)NCCC[Si](OC)(OC)OC] | N,N-Diethyl- N′-[3- (trimethoxysilyl) propyl]urea |
| D | 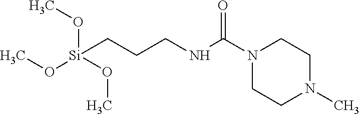 | 1-([3-(Trimethoxysilyl) propyl]carbamoyl)-4- methylpiperazine |
| E | 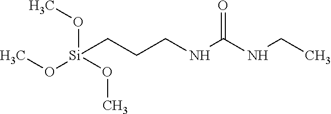 [SMILES: CCNC(=O)NCCC[Si](OC)(OC)OC] | N-Ethyl-N′-[3- (trimethoxysilyl)propyl]urea |
| F | 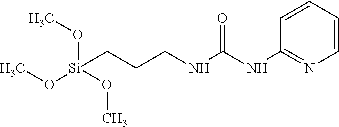 [SMILES: CO[Si](CCCNC(=O)Nc1ccccn1)(OC)OC] | N-(Pyridin-2-yl)-N′-[3- (trimethoxysilyl)propyl]urea |
| G | 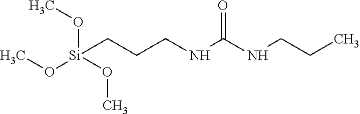 [SMILES: CCCNC(=O)NCCC[Si](OC)(OC)OC] | N-Propyl-N′-[3- (trimethoxysilyl)propyl]urea |
| H | 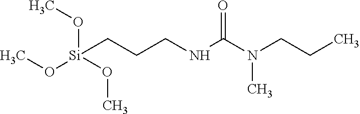 [SMILES: CCCN(C)C(=O)NCCC[Si](OC)(OC)OC] | N-Methyl-N-propyl-N′-[3- (trimethoxysilyl)propyl]urea |
| I | 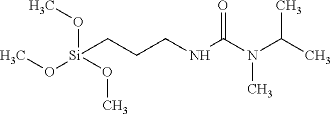 [SMILES: CO[Si](CCCNC(=O)N(C)C(C)C)(OC)OC] | N-Isopropyl-N-methyl-N′-[3- (trimethoxysilyl)propyl]urea |
| J | 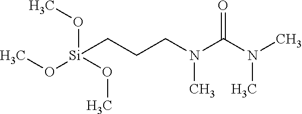 | N,N-Dimethyl-N′-methyl-N′-[3- (trimethoxysilyl)propyl]urea |
| K | 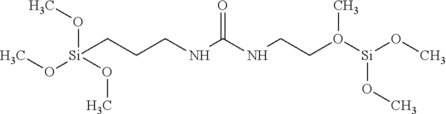 | N,N′-Bis[3- (trimethoxysilyl)propyl]urea |
| L | 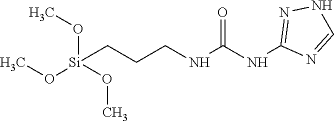 [SMILES: CO[Si](CCCNC(=O)Nc1nc[nH]n1)(OC)OC] | N-(1H-1,2,4-triazol-3-yl)-N′-[3- (trimethoxysilyl)propyl]urea |
| M | 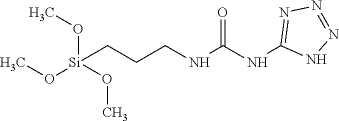 [SMILES: CO[Si](CCCNC(=O)Nc1nnn[nH]1)(OC)OC] | N-(1H-tetrazol-5-yl)-N′-[3- (trimethoxysilyl)propyl]urea |
| N | 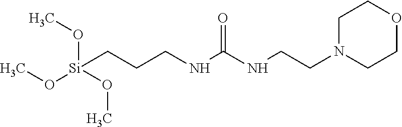 [SMILES: CO[Si](CCCNC(=O)NCCN1CCOCC1)(OC)OC] | N-[2-(morpholin- 4-yl)ethyl]-N′-[3- (trimethoxysilyl)propyl]urea |
| O | 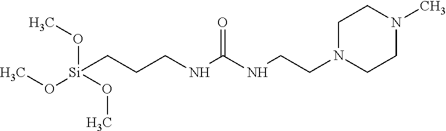 | N-[2-(4-methylpiperazin- 1-yl)ethyl]-N′-[3- (trimethoxysilyl)propyl]urea |

As can be seen in Table 1, Component A significantly reduced the dpolysilicon etch rate both with and without silicon loading. Component A includes a urea group —N(CH₃)₂ on one end of Component A. Despite the similar structure, Component J does not provide the same impact on the dpolysilicon etch rate. Compound E shows a similar low dpolysilicon etch rate comparable to Component A.

### Aspects

Various Aspects are described below. It is to be understood that any one or more of the features recited in the following Aspect(s) can be combined with any one or more other Aspect(s).
Aspect 1. A composition comprising:
   an inhibitor compound of the formula:

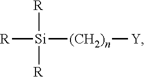

where:
   R is independently an alkoxy or a hydroxyl;
   n is at least 1; and
   Y is a group of the formula:

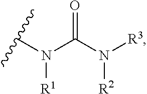

where:
R¹ is a hydrogen, an alkyl, a cycloalkyl, an aryl, an aralkyl, a silylalkyl, or an aminoalkyl; and
R² is a hydrogen, an alkyl, a cycloalkyl, an aryl, an aralkyl, a silylalkyl, or an aminoalkyl,
R³ is a hydrogen, an alkyl, a cycloalkyl, an aryl, an aralkyl, a silylalkyl, or an aminoalkyl, or
R² and R³ are bonded to each other to form a carbocycle or a heterocycle.
Aspect 2. The composition of aspect 1, wherein, when R² is a hydrogen and when R³ is a hydrogen, R¹ is not a hydrogen.
Aspect 3. The composition of aspect 1 or 2, wherein R is —O(C₁-C₅ alkyl) and n is 1 to 3.
Aspect 4. The composition of aspect 1, wherein:
   R¹ is a hydrogen;
   R² is a hydrogen; and
   R³ is a C₁-C₁₀ alkyl.
Aspect 5. The composition of aspect 1, wherein:
   R¹ is a hydrogen;
   R² is a hydrogen; and
   R³ is an aralkyl.
Aspect 6. The composition of aspect 1, wherein:
   R¹ is a hydrogen;
   R² is a hydrogen; and
   R³ is a silylalkyl.
Aspect 7. The composition of aspect 1, wherein:
   R¹ is a hydrogen;
   R² is an alkyl; and
   R³ is an alkyl.
Aspect 8. The composition of aspect 1, wherein:
   R¹ is a hydrogen;
   R² is an aralkyl; and
   R³ is a silylalkyl.
Aspect 9. The composition of aspect 1, wherein:
   R¹ is a hydrogen;
   R² is an alkyl; and
   R³ is an aminoalkyl.
Aspect 10. The composition of aspect 1, wherein:
   R¹ is a hydrogen; and
   R² and R³ are bonded to each other to form a heterocyclic ring or a substituted heterocyclic ring.
Aspect 11. The composition of any one of Aspects 1 to 10, wherein Y is at least one of:

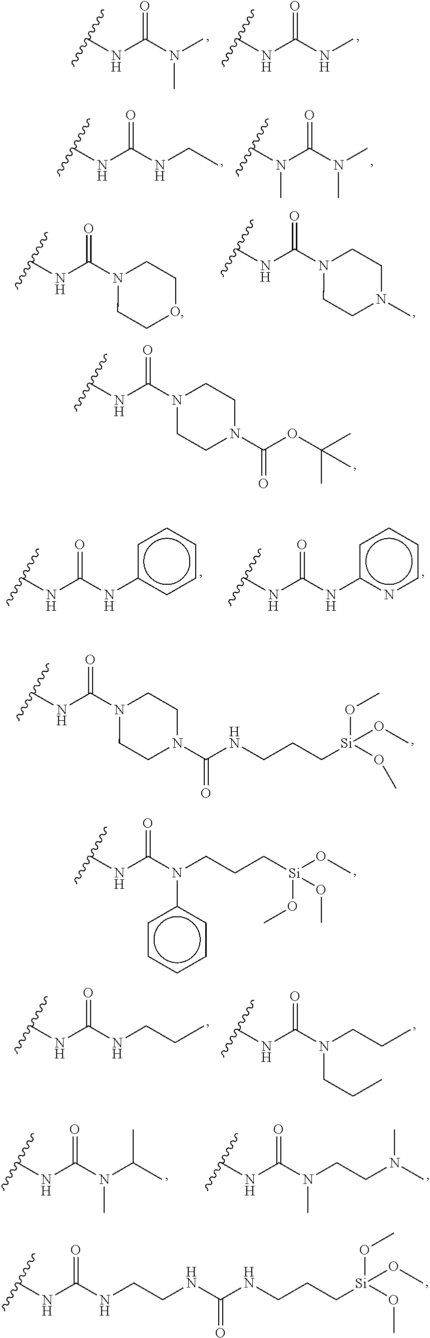

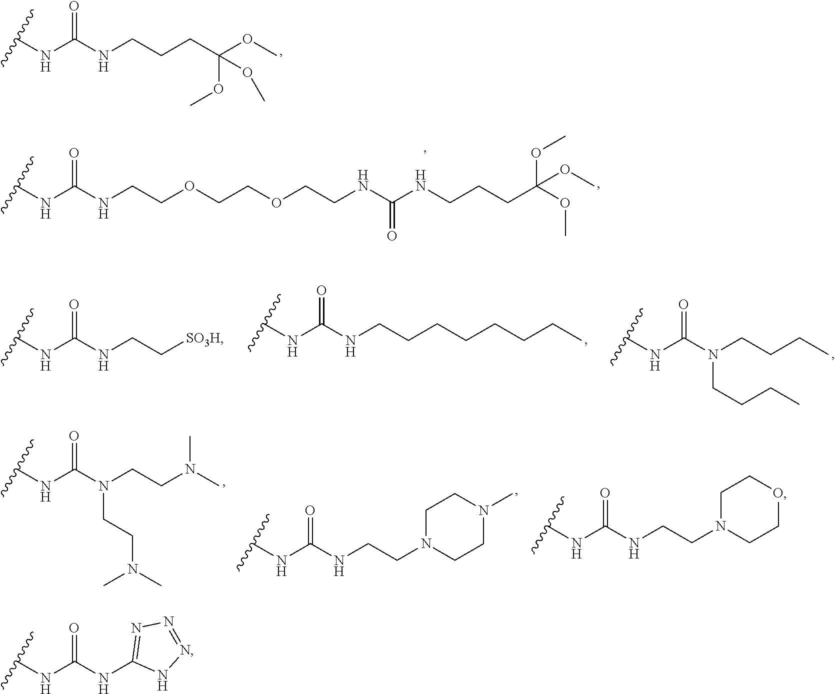

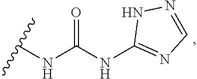 [SMILES: *NC(=O)Nc1ncn[nH]1]

or
any combination thereof.
Aspect 12. A composition comprising:
   a phosphoric acid compound;
   an alkyl ammonium silicate compound; and
   1% to 25% by weight of an inhibitor compound based on a total weight of the composition,
      wherein the inhibitor compound comprises a compound of the formula:

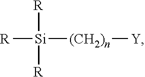

where:
   R is independently an alkoxy or a hydroxyl;
   n is at least 1; and
   Y is a group of the formula:

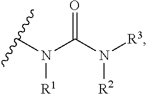

where:
R¹ is a hydrogen, an alkyl, a cycloalkyl, an aryl, an aralkyl, a silylalkyl, or an aminoalkyl; and
R² is a hydrogen, an alkyl, a cycloalkyl, an aryl, an aralkyl, a silylalkyl, or an aminoalkyl,
R³ is a hydrogen, an alkyl, a cycloalkyl, an aryl, an aralkyl, a silylalkyl, or an aminoalkyl, or
R² and R³ are bonded to each other to form a carbocycle or a heterocycle.
Aspect 13. The composition of aspect 12, wherein the composition comprises:
   70% to 80% by weight of the phosphoric acid compound based on the total weight of the composition; and
   1% to 20% by weight of the alkyl ammonium silicate compound based on the total weight of the composition.
Aspect 14. The composition of aspect 12 or 13, wherein the composition comprises:
   1% to 10% by weight of the inhibitor compound based on the total weight of the composition.
Aspect 15. The composition of any one of aspects 12 to 14, wherein, when R² is a hydrogen and when R³ is a hydrogen, R¹ is not a hydrogen.
Aspect 16. The composition of any one of aspects 12 to 14, wherein R is —O(C₁-C₅alkyl) and n is 1 to 3.
Aspect 17. The composition of any one of aspects 12 to 14, wherein:
   R¹ is a hydrogen;
   R² is a hydrogen; and
   R³ is a C₁-C₁₀ alkyl, an aralkyl, or a silylalkyl.
Aspect 18. The composition of any one of aspects 12 to 14, wherein:
   R¹ is a hydrogen;
   R² is an alkyl or an aralkyl; and
   R³ is an alkyl, a silylalkyl, or an aminoalkyl.
Aspect 19. The composition of any one of aspects 12 to 14, wherein:
   R¹ is a hydrogen; and
   R² and R³ are bonded to each other to form a heterocyclic ring or a substituted heterocyclic ring.
Aspect 20. A method comprising:
   obtaining a composition comprising an inhibitor compound of the formula:

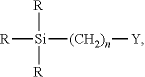

where:
   R is independently an alkoxy or a hydroxyl;
   n is at least 1; and
   Y is a group of the formula:

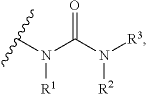

where:
R¹ is a hydrogen, an alkyl, a cycloalkyl, an aryl, an aralkyl, a silylalkyl, or an aminoalkyl; and
R² is a hydrogen, an alkyl, a cycloalkyl, an aryl, an aralkyl, a silylalkyl, or an aminoalkyl,
R³ is a hydrogen, an alkyl, a cycloalkyl, an aryl, an aralkyl, a silylalkyl, or an aminoalkyl, or
R² and R³ are bonded to each other to form a carbocycle or a heterocycle;
selectively etching silicon nitride from a structure comprising silicon nitride.

What is claimed is:

1. A composition comprising:
an inhibitor compound of the formula: 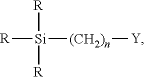
where:
R is independently an alkoxy or a hydroxyl;
n is at least 1; and
Y is a group of the formula: 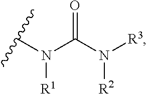
where:
R¹ is a hydrogen, an alkyl, a cycloalkyl, an aryl, an aralkyl, a silylalkyl, or an aminoalkyl; and
R² is a hydrogen, an alkyl, a cycloalkyl, an aryl, an aralkyl, a silylalkyl, or an aminoalkyl,
R³ is a hydrogen, an alkyl, a cycloalkyl, an aryl, an aralkyl, a silylalkyl, or an aminoalkyl, or
R² and R³ are bonded to each other to form a carbocycle or a heterocycle.

2. The composition of claim 1, wherein, when R² is a hydrogen and when R³ is a hydrogen, R¹ is not a hydrogen.

3. The composition of claim 1, wherein R is —O(C₁-C₅alkyl) and n is 1 to 3.

4. The composition of claim 1, wherein:
R¹ is a hydrogen;
R² is a hydrogen; and
R³ is a C₁-C₁₀ alkyl.

5. The composition of claim 1, wherein:
R¹ is a hydrogen;
R² is a hydrogen; and
R³ is an aralkyl.

6. The composition of claim 1, wherein:
R¹ is a hydrogen;
R² is a hydrogen; and
R³ is a silylalkyl.

7. The composition of claim 1, wherein:
R¹ is a hydrogen;
R² is an alkyl; and
R³ is an alkyl.

8. The composition of claim 1, wherein:
R¹ is a hydrogen;
R² is an aralkyl; and
R³ is a silylalkyl.

9. The composition of claim 1, wherein:
R¹ is a hydrogen;
R² is an alkyl; and
R³ is an aminoalkyl.

10. The composition of claim 1, wherein:
R¹ is a hydrogen; and
R² and R³ are bonded to each other to form a heterocyclic ring or a substituted heterocyclic ring.

11. The composition of claim 1, wherein Y is at least one of: 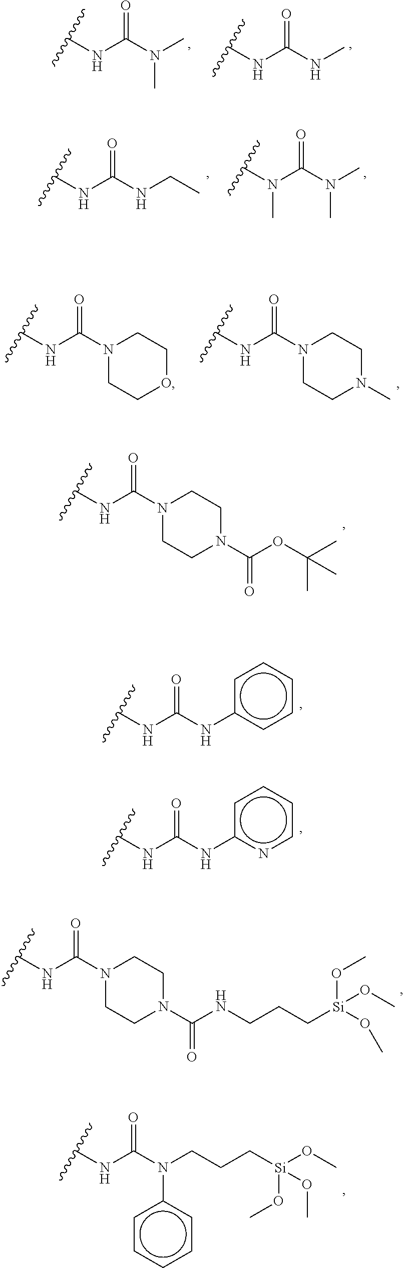 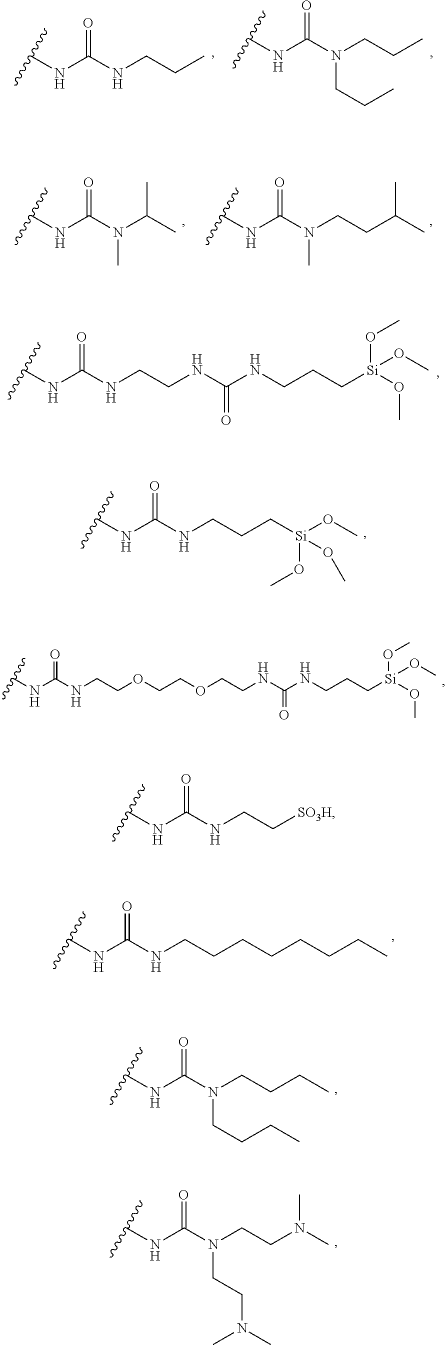 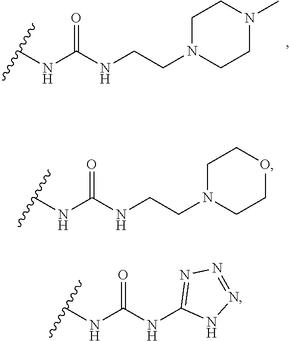 [SMILES: *NC(=O)NCCN1CCN(C)CC1 ; *NC(=O)NCCN1CCOCC1 ; *NC(=O)Nc1nnn[nH]1] 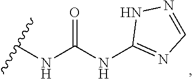 [SMILES: *NC(=O)Nc1ncn[nH]1]
or
any combination thereof.

12. A composition comprising:
a phosphoric acid compound;
an alkyl ammonium silicate compound; and
1% to 25% by weight of an inhibitor compound based on a total weight of the composition,
wherein the inhibitor compound comprises a compound of the formula: 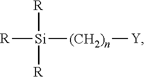
where:
R is independently an alkoxy or a hydroxyl;
n is at least 1; and
Y is a group of the formula: 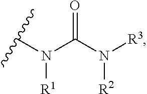
where:
R¹ is a hydrogen, an alkyl, a cycloalkyl, an aryl, an aralkyl, a silylalkyl, or an aminoalkyl; and
R² is a hydrogen, an alkyl, a cycloalkyl, an aryl, an aralkyl, a silylalkyl, or an aminoalkyl,
R³ is a hydrogen, an alkyl, a cycloalkyl, an aryl, an aralkyl, a silylalkyl, or an aminoalkyl, or
R² and R³ are bonded to each other to form a carbocycle or a heterocycle.

13. The composition of claim 12, wherein the composition comprises:
70% to 80% by weight of the phosphoric acid compound based on the total weight of the composition; and
1% to 20% by weight of the alkyl ammonium silicate compound based on the total weight of the composition.

14. The composition of claim 12, wherein the composition comprises:
1% to 10% by weight of the inhibitor compound based on the total weight of the composition.

15. The composition of claim 12, wherein, when R² is a hydrogen and when R³ is a hydrogen, R¹ is not a hydrogen.

16. The composition of claim 12, wherein R is —O(C₁-C₅alkyl) and n is 1 to 3.

17. The composition of claim 12, wherein:
R¹ is a hydrogen;
R² is a hydrogen; and
R³ is a C₁-C₁₀ alkyl, an aralkyl, or a silylalkyl.

18. The composition of claim 12, wherein:
R¹ is a hydrogen;
R² is an alkyl or an aralkyl; and
R³ is an alkyl, a silylalkyl, or an aminoalkyl.

19. The composition of claim 12, wherein:
R¹ is a hydrogen; and
R² and R³ are bonded to each other to form a heterocyclic ring or a substituted heterocyclic ring.

20. A method comprising:
obtaining a composition comprising an inhibitor compound of the formula: 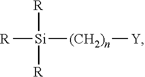
where:
R is independently an alkoxy or a hydroxyl;
n is at least 1; and
Y is a group of the formula: 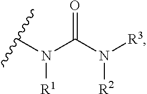
where:
R¹ is a hydrogen, an alkyl, a cycloalkyl, an aryl, an aralkyl, a silylalkyl, or an aminoalkyl; and
R² is a hydrogen, an alkyl, a cycloalkyl, an aryl, an aralkyl, a silylalkyl, or an aminoalkyl,
R³ is a hydrogen, an alkyl, a cycloalkyl, an aryl, an aralkyl, a silylalkyl, or an aminoalkyl, or
R² and R³ are bonded to each other to form a carbocycle or a heterocycle;
selectively etching silicon nitride from a structure comprising silicon nitride.
